(19) United States
(12) Patent Application Publication
(10) Pub. No.: US 2026/0016620 A1
(43) Pub. Date: Jan. 15, 2026

(54) OPTICAL LENS AND METHOD FOR FABRICATING THE SAME

(71) Applicant: Panasonic Intellectual Property Management Co., Ltd., Osaka (JP)

(72) Inventors: EIJI TAKEDA, Osaka (JP); KEIGO MASUDA, Osaka (JP)

(21) Appl. No.: 19/335,016

(22) Filed: Sep. 22, 2025

Related U.S. Application Data
(63) Continuation of application No. PCT/JP2024/013631, filed on Apr. 2, 2024.

(30) Foreign Application Priority Data
Apr. 21, 2023 (JP) 2023-070008

(51) Int. Cl. G02B 3/00

(52) U.S. Cl. CPC G02B 3/0056; G02B 3/0012

(57) ABSTRACT

An optical lens includes a plurality of substrates arrayed two-dimensionally or one-dimensionally. A surface of each of the plurality of substrates is provided with a plurality of microstructural bodies corresponding to part of a single lens.

### BACKGROUND

### 1. Technical Field

The present disclosure relates to an optical lens and a method for fabricating the same.

### 2. Description of the Related Art

In recent years, a meta-lens having a microscopic surface structure called “meta-surface” has been under study and development. A meta-surface is a surface having a meta-material structure that achieves an optical function that does not occur in nature. A meta-lens can achieve, with one thin flat-plate structure, an optical function that is comparable to that of a combination of a plurality of conventional optical lenses. For this reason, a meta-lens can contribute to reductions in size and weight of lens-equipped devices such as cameras, LiDAR sensors, projectors, and AR (augmented reality) displays. Examples of a meta-lens and a device including a meta-lens are disclosed, for example, in Japanese Unexamined Patent Application Publication (Translation of PCT Application) No. 2019-516128 and Japanese Unexamined Patent Application Publication No. 2021-71727.

Japanese Unexamined Patent Application Publication (Translation of PCT Application) No. 2019-516128 discloses a meta-lens including a substrate and a plurality of nanostructural bodies placed on top of the substrate. In this meta-lens, the plurality of nanostructural bodies bring about optical phase shifts that vary depending on their positions, and the optical phase shifts brought about separately by each nanostructural body define a phase profile of the meta-lens. The optical phase shift of each nanostructural body depends on the position of the nanostructural body and the size or orientation of the nanostructural body. Examples of nanostructural bodies include nanofins and nanopillars. According to the description, a desired phase shift is achieved by adjusting the angle of placement of each nanofin or adjusting the size of each nanopillar.

Japanese Unexamined Patent Application Publication No. 2021-71727 discloses a miniaturized lens assembly including a meta-lens and an electronic device including the same. This meta-lens includes a nanostructural array and is configured to form an identical phase delay profile for light of at least two different wavelengths included in incident light. In order to achieve a desired phase delay profile, this meta-lens is configured such that the width of each of a plurality of inner columns included in the nanostructural array is appropriately determined according to the required amount of phase delay.

### SUMMARY

A conventional meta-lens is limited in size because the conventional meta-lens has a single substrate provided with a plurality of microstructural bodies. One non-limiting and exemplary embodiment provides a large-size optical lens by arraying a plurality of substrates each provided with a plurality of microstructural bodies.

In one general aspect, the techniques disclosed here feature an optical lens including a plurality of substrates arrayed two-dimensionally or one-dimensionally. A surface of each of the plurality of substrates is provided with a plurality of microstructural bodies corresponding to part of a single lens.

It should be noted that general or specific embodiments may be implemented as a system, an apparatus, a method, an integrated circuit, a computer program, a computer readable storage medium such as a storage disk, or any selective combination thereof. The computer-readable storage medium can include a volatile storage medium or can include a nonvolatile storage medium such as a CD-ROM (compact disc read-only memory). The apparatus can be constituted by one or more apparatuses. In a case where the apparatus is constituted by two or more apparatuses, the two or more apparatuses may be placed in one piece of equipment or may be separately placed in two or more separate pieces of equipment. The term “apparatus” herein or in the claims can not only mean one apparatus but also mean a system composed of a plurality of apparatuses.

An aspect of the present disclosure makes it possible to achieve a large-size optical lens by arraying a plurality of substrates each provided with a plurality of microstructural bodies.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a perspective view schematically showing an example of a meta-lens;

FIG. 2 is a perspective view schematically showing an example of a structure of one unit cell;

FIG. 3 is a diagram schematically showing a function of the meta-lens;

FIG. 4 is a diagram schematically showing a configuration of a meta-lens according to an exemplary Embodiment 1 of the present disclosure;

FIG. 5A is a diagram schematically showing an example of an ideal phase profile in an unwrapped state;

FIG. 5B is a diagram schematically showing an ideal phase profile wrapped in a range of phases of −π to π;

FIG. 5C is a diagram schematically showing an example of sampling for achieving an ideal phase profile;

FIG. 6 is a diagram schematically showing an example of contour lines of a phase in the meta-lens according to Embodiment 1;

FIG. 7A is a diagram for explaining a method of fabricating a meta-lens according to Embodiment 1;

FIG. 7B is a diagram for explaining the method of fabricating a meta-lens according to Embodiment 1;

FIG. 8 is a side view schematically showing a modification of the meta-lens according to Embodiment 1;

FIG. 9 is a diagram schematically showing a configuration of a meta-lens according to an exemplary Embodiment 2 of the present disclosure;

FIG. 10A is a diagram for explaining a method of fabricating a meta-lens according to Embodiment 2;

FIG. 10B is a diagram for explaining the method of fabricating a meta-lens according to Embodiment 2;

FIG. 10C is a diagram for explaining the method of fabricating a meta-lens according to Embodiment 2; and

FIG. 10D is a diagram for explaining the method of fabricating a meta-lens according to Embodiment 2.

### DETAILED DESCRIPTIONS

The following describes exemplary embodiments of the present disclosure. It should be noted that the embodiments to be described below each illustrate a comprehensive and specific example. The numerical values, shapes, constituent elements, placement and topology of constituent elements, steps, orders of steps, or other features that are shown in the following embodiments are just a few examples and are not intended to limit the technology of the present disclosure. Further, those of the constituent elements in the following embodiments which are not recited in an independent claim reciting the most superordinate concept are described as optional constituent elements. Further, the drawings are schematic views and are not necessarily strict illustrations. Further, in the drawings, identical or similar constituent elements are given identical reference signs. A repeated description may be omitted or simplified.

The term “light” herein refers to not only visible light (with wavelengths of approximately 400 nm to approximately 700 nm) but also invisible light. The term “invisible light” means electromagnetic waves included in wavelength ranges of ultraviolet radiation (with wavelengths of approximately 10 nm to approximately 400 nm), infrared radiation (with wavelengths of approximately 700 nm to approximately 1 mm), or radio waves (with wavelengths of approximately 1 mm to approximately 1 m). An optical lens in the present disclosure can be used for not only visible light but also invisible light such as ultraviolet radiation, infrared radiation, or radio waves.

### Underlying Knowledge Forming Basis of the Present Disclosure

First, an example of a basic configuration of an optical lens and the inventors' findings are described.

In the following description, the optical lens is also referred to as “meta-lens”. The meta-lens is an optical element having at a surface thereof a plurality of microstructural bodies that are smaller than wavelengths of incident light, and those microstructural bodies bring about phase shifts by which a lens function is achieved. It is possible to adjust the optical properties such as phase, amplitude, or polarization of incident light by appropriately designing the shape, size, orientation, and placement of each microstructural body.

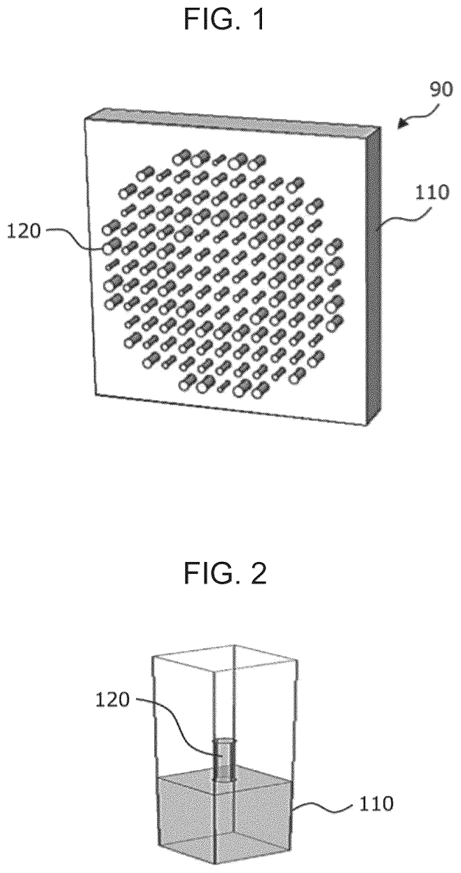

FIG. 1 is a perspective view schematically showing an example of a conventional meta-lens. A meta-lens 90 shown in FIG. 1 includes a substrate 110 and a plurality of microstructural bodies 120 provided at a surface of the substrate 110. Each microstructural body 120 in this example is a columnar body, also called “pillar”, that is similar in shape to a circular cylinder. A unit element including one microstructural body 120 in the meta-lens 90 is referred to as “unit cell”. The meta-lens 90 is an aggregate of a plurality of unit cells.

FIG. 2 is a perspective view schematically showing an example of a structure of one unit cell. One unit cell includes part of the substrate 110 and one microstructural body 120 projecting from the part of the substrate 110. Each unit cell causes incident light to undergo a phase shift according to a structure of the microstructural body 120.

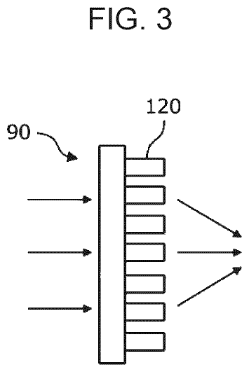

FIG. 3 is a diagram schematically showing a function of the meta-lens 90. In FIG. 3, the arrows indicate examples of rays. In this example, the meta-lens 90 has a property of condensing incident light as is the case with a conventional convex lens. In the example shown in FIG. 3, incident light falling on the substrate 110 of the meta-lens 90 is subjected by the array of microstructural bodies 120 to phase variations differing according to position, and is condensed. The shape, width, height, orientation, or other attributes of each microstructural body 120 are appropriately determined so that the desired light-condensing property is achieved. The structure of each microstructural body 120 can be appropriately determined, for example, based on data representing the phase profile to be achieved and a result of an electromagnetic field simulation.

The microstructural bodies 120 each has a subwavelength size (e.g. width and height) shorter than the wavelength of incident light falling on the meta-lens 90 and can be placed at subwavelength spacings or pitches. A “spacing” between microstructural bodies 120 is the center-to-center distance between two microstructural bodies 120 that are adjacent to each other when seen from a direction perpendicular to the surface of the substrate 110.

The meta-lens 90 can be designed to achieve a desired optical property for light in a predetermined target wavelength range. The target wavelength range is, for example, a wavelength range defined according to specification. In a case where a lower limit of the target wavelength range is, for example, 1 μm, the size of and the spacing between the microstructural bodies 120 can be set to a value shorter than 1 μm. Such a microstructural body of nanoscale size smaller than 1 μm is sometimes called “submicron structural body” or “nanostructural body”. In a case where the target wavelength range is an infrared wavelength range, the size of and the spacing between the microstructural bodies 120 may be greater than 1 μm.

The number of microstructural bodies 120 that are provided at a surface of the meta-lens 90 is appropriately determined according to the lens function to be achieved. The number of microstructural bodies 120 falls within a range of, for example, 100 to 10,000 and, in some cases, may be smaller than 100 or larger than 10,000.

The conventional meta-lens has a single substrate provided with a plurality of microstructural bodies. Accordingly, the conventional meta-lens is limited in size. The inventors found this problem and conceived of an optical lens according to an embodiment of the present disclosure to solve the problem. According to an embodiment of the present disclosure, a large-size optical lens that functions as a single lens can be achieved by arraying a plurality of substrates each provided with a plurality of microstructural bodies. The following describes a configuration of the optical lens according to the present embodiment. A structure of each microstructural body 120 in the conventional meta-lens 90 and a method for designing the same can also be applied to the optical lens according to the present embodiment.

An optical lens according to an embodiment of the present disclosure is used for light in a predetermined target wavelength range. The optical lens includes a plurality of substrates arrayed two-dimensionally or one-dimensionally. A surface of each of the plurality of substrates is provided with a plurality of microstructural bodies corresponding to part of a single lens.

The “target wavelength range” here is a wavelength range of light for which the optical lens is supposed to be used, and can be determined based on the specifications of the optical lens or the specifications of a device mounted with the optical lens. The target wavelength range may include, for example, at least part of a wavelength range of visible light (from approximately 400 nm to approximately 700 nm). Alternatively, the target wavelength range may include, for example, at least part of a wavelength range of ultraviolet radiation (from approximately 10 nm to approximately 400 nm). Alternatively, the target wavelength range may include, for example, at least part of a wavelength range of infrared radiation (from approximately 700 nm to approximately 1 mm). Alternatively, the target wavelength range may include, for example, at least part of a wavelength range of radio waves (from approximately 1 mm to approximately 1 m). In an example, the target wavelength range can include at least part of a wavelength range of infrared radiation of 2.5 μm to 25 μm. The wavelength range of 2.5 μm to 25 μm can be suitably utilized for an infrared sensing device such as a LiDAR sensor or an infrared camera. The term “wavelength” herein means a wavelength in free space unless otherwise noted. Further, the term “single lens” herein means one lens.

The substrate and each microstructural body can be made of a material having translucency with respect to light in the target wavelength range. The phrase “having translucency” here means having a property of transmitting incident light at a transmittance higher than 50%. In an embodiment, the substrate 110 and each microstructural body 120 may be made of a material that transmits, at a transmittance of 80% or higher, light in the target wavelength range.

A “spacing” between microstructural bodies means the center-to-center distance between two microstructural bodies that are adjacent to each other when seen from a direction perpendicular to the surface (hereinafter also referred to as “lens surface”) of the substrate. In a case where a shortest wavelength in the target wavelength range is, for example, 2.5 μm, the center-to-center distance between two of the plurality of microstructural bodies that are adjacent to each other is shorter than 2.5 μm. Since the width of a microstructural body is smaller than the spacing between microstructural bodies, the width of a microstructural body is shorter than a shortest wavelength in the target wavelength range.

The spacing between the microstructural bodies 120 is determined according to a phase profile that the optical lens should achieve. The phase profile represents a distribution within a lens surface of the shift amount of phase (hereinafter sometimes referred to simply as “phase”) of emitted light with respect to the phase of incident light falling on the optical lens. The phase profile can be expressed, for example, by a function of phase with respect to position within the lens surface or distance from an optical axis. The phase profile indicates different phases according to position within the lens surface. In the embodiment, the spacing between microstructural bodies is determined according to the phase profile to be achieved so as to differ according to position on the lens surface (e.g. distance from the optical axis).

The following describes the details of meta-lenses according to Embodiments 1 and 2. In Embodiment 1, a meta-lens that functions as a single lens is obtained by arraying four substrates in two rows and two columns. In Embodiment 2, a meta-lens that functions as a single lens is obtained by arraying nine substrates in three rows and three columns. Note, however, that the number of substrates is not limited to 4 or 9. The number of substrates may be 2, 3, 5 to 9, or larger than or equal to 10. The plurality of substrates may be arrayed two-dimensionally or may be arrayed one-dimensionally.

### Embodiment 1

### Example Configuration of Meta-Lens

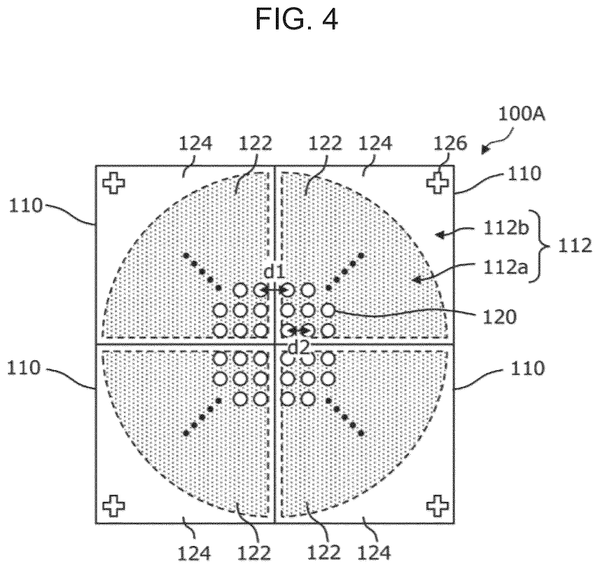

The following describes, with reference to FIG. 4, an example configuration of a meta-lens according to Embodiment 1 of the present disclosure. The meta-lens according to Embodiment 1 of the present disclosure can be used in combination with an image sensor, for example, in an imaging device. The meta-lens can also be used in a telescope, a microscope, or an optical scanner. Note, however, that the meta-lens is not limited to these uses.

FIG. 4 is a diagram schematically showing a configuration of a meta-lens according to an exemplary Embodiment 1 of the present disclosure. A meta-lens 100A shown in FIG. 4 includes four substrates 110 arrayed two-dimensionally or, more specifically, in two rows and two columns. Side surfaces of two adjacent substrates 110 face each other.

Each substrate 110 has the shape of a regular square. The four substrates 110 form the shape of a regular square. Of the four substrates 110, two adjacent substrates 110 have their side surfaces bonded to each other. This bonding, for example, may be adhesive bonding or may be non-adhesive direct bonding. In the case of direct bonding, the side surfaces of the two adjacent substrates 110 are joined to each other under pressure and/or on heating after being subjected to cleaning and surface treatment.

In the case of adhesive bonding, the side surfaces of the two adjacent substrates 110 are at an adhesive distance from each other. In the case of direct bonding, the side surfaces of the two adjacent substrates 110 are in contact with each other. When two surfaces face each other herein, it means not only a case where the two surfaces are at a distance from each other but also a case where the two surfaces are in contact with each other.

A surface 112 of each substrate 110 has a principal area 112a and a peripheral area 112b located outside the principal area 112a. A hatched area shown in FIG. 4 represents a principal area 112a. The principal area 112a has the shape of a quarter circle. More specifically, the peripheral area 112b is located around the principal area 112a and surrounds the principal area 112a.

The principal area 112a of the surface 112 of each substrate 110 is provided with a plurality of microstructural bodies 120 corresponding to part of a single lens. For simplicity, FIG. 4 schematically shows a plurality of microstructural bodies 120 provided near the right angle of the quarter circle of the principal area 112a. The peripheral area 112b is not provided with the plurality of microstructural bodies 120. However, as shown in FIG. 4, an alignment mark 126 may be provided in a wide-margin portion of the peripheral area 112b. The alignment mark 126 is useful in forming a single lens by placing the substrate 110 in an appropriate orientation. Although, in the example shown in FIG. 4, the alignment mark 126 has the shape of a cross, the alignment mark 126 is not limited to this shape. For example, the alignment mark 126 may have a circular shape, may have a star shape of a star, or may a linear shape.

The plurality of microstructural bodies 120 may be provided directly on the surface 112 of the substrate 110 or may be provided indirectly at the surface 112 of the substrate 110 via another member. Alternatively, the plurality of microstructural bodies 120 may be provided at spacings from the surface 112 of the substrate 110, for example, by using spacers. The same applies to the alignment mark 126.

Let it be assumed that in a top view of the surface 112 as seen from a direction perpendicular to the surface 112, an area on the substrate 110 that overlaps the principal area 112a is a lens area 122 and an area on the substrate 110 that overlaps the peripheral area 112b is a non-lens area 124. In this case, it can be said that the substrate 110 includes a lens area 122 and a non-lens area 124.

The lens area 122 functions as part of a single lens and shifts the phase of incident light. The lens area 122 includes a plurality of microstructural bodies 120. A plurality of the lens areas 122 of the meta-lens 100A are identical in shape to one another. The lens areas 122a are equivalent to four equal parts into which a single circular lens has been divided.

The non-lens area 124 has a peripheral area 112b as a surface and does not shift the phase of incident light. The non-lens area 124 does not include a plurality of microstructural bodies 120. However, as shown in FIG. 4, the non-lens area 124 may include an alignment mark 126. A plurality of the non-lens areas 124 of the meta-lens 100A are identical in shape to one another. The non-lens area 124 is located outside the lens area 122. More specifically, the non-lens area 124 is located around the lens area 122 and surrounds the lens area 122. An inner end of the non-lens area 124 matches an end of the lens area 122. The non-lens area 124 is a margin area that remains after the process of fabricating the substrate 110. A method for fabricating the meta-lens 100A will be described later.

According to Embodiment 1, a large-size meta-lens 100A that functions as a single lens can be achieved by arraying, in two rows and two columns in an appropriate orientation, four substrates 110 whose lens areas 122 are identical in shape to one another.

### Method for Designing Lens Area

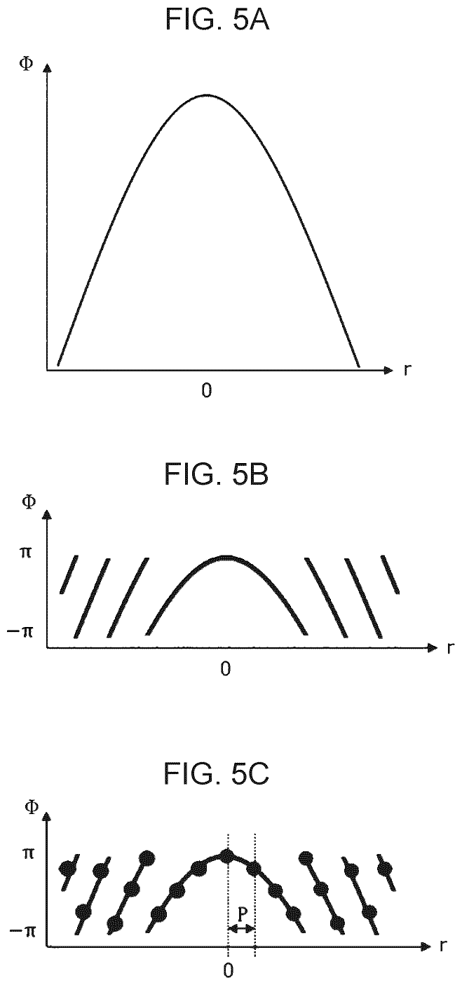

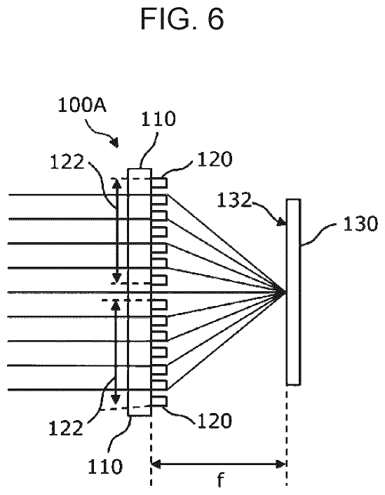

A method for designing a lens area 122 is described with reference to FIGS. 5A to 6. The spacing between the microstructural bodies 120 in the lens area 122 is determined according to a phase profile for achieving a desired lens function.

FIG. 5A is a diagram schematically showing an example of an ideal phase profile in an unwrapped state. The horizontal axis represents coordinates r with the center of the lens area 122 at the origin, and the vertical axis represents phase @. In the example shown in FIG. 5A, the phase @ monotonically decreases in an upwardly convex shape as the position r increases, and the degree of the decrease monotonically increases as the position r increases. FIG. 5B is a diagram schematically showing an ideal phase profile wrapped in a range of phases of −π to π. FIG. 5C is a diagram schematically showing an example of sampling for achieving an ideal phase profile. In FIG. 5C, the black dots indicate examples of positions (i.e. sampling points) of microstructural bodies 120. As shown in these drawings, an adequate number of microstructural bodies 120 are placed in each of a plurality of sections wrapped in a range of −π to π. According to the sampling theorem, two or more microstructural bodies 120 are placed in one continuous section from −π to π.

In the example shown in FIGS. 5A to 5C, an area near the center of the lens area 122 and an area near the end of the lens area 122 differ in phase steepness from each other. The area near the end is higher in the rate of change in the phase @ with respect to a change in the position r than the area near the center. In such a case, a pitch P2 between microstructural bodies 120 located near the end may be smaller than a pitch P1 between microstructural bodies 120 located near the center. Such placement of microstructural bodies 120 makes it possible to more accurately reproduce an ideal phase profile.

An increase in the number of microstructural bodies 120 included in one continuous section from −π to π, i.e. an increase in the number of samples, leads to further improvement in reproducibility of a phase profile. For example, placing three or more or four or more microstructural bodies 120 in each section makes it possible to further improve the reproducibility of a phase profile.

More detailed methods for designing a lens area 122 are disclosed in Japanese Patent Application No. 2022-058051 (filed on Mar. 31, 2022), Japanese Patent Application No. 2022-058052 (filed on Mar. 31, 2022), and Japanese Patent Application No. 2022-058053 (filed on Mar. 31, 2022), the entire contents of which are hereby incorporated by reference.

### Configuration of Non-Lens Area

A configuration of the non-lens area 124 is described. The peripheral area 112b, which is a surface of the non-lens area 124, has a planar shape. The non-lens area 124, whose surface has a planar shape, does not shift the phase of incident light. The “planar shape” here means a planeness of 25 μm or less as expressed by TTV (total thickness variation).

According to JIS B 0621 “Definitions and designations of geometrical deviations”, the planeness is defined as the “magnitude of a deviation from the geometrically accurate plane (geometric plane) of a planar form”. Specifically, the planeness is equivalent to the distance between two upper and lower imaginary planes between which a target surface is interposed. The planeness can be measured with laser light in a non-contact manner.

### Spacing Between Two Adjacent Microstructural Bodies 120

All microstructural bodies in the four substrates 110 include a plurality of microstructural bodies 120 within each substrate 110. Of the four substrates 110, two adjacent substrates are separated from each other by a boundary. As shown in FIG. 4, the spacing d1 between two of all microstructural bodies that are adjacent to each other via the boundary is different from the spacing d2 between two of all microstructural bodies that are adjacent to each other within each substrate 110. More specifically, the minimum value of the spacing d1 is greater than the maximum value of the spacing d2. This is because the non-lens area 124 is located around the lens area 122. In a case where the maximum value of the spacing d1 is five times or less as great as the maximum value of the spacing d2, the meta-lens 100A properly functions as a single lens.

### How Light is Condensed

How incident light is condensed by the meta-lens 100A according to Embodiment 1 is described with reference to FIG. 6. FIG. 6 is a schematic ray tracing diagram of a case where light falls perpendicularly on the meta-lens 100A according to Embodiment 1. The straight solid lines shown in FIG. 6 represent rays of incident light from a physical object.

FIG. 6 shows not only the meta-lens 100A but also an image sensor 130 that has an imaging surface 132 and that detects light in a predetermined target wavelength range. The meta-lens 100A and the image sensor 130 are placed at a spacing equivalent to the focal length f on the specifications of the meta-lens 100A. The focal point of the meta-lens 100A is located on the imaging surface 132 of the image sensor 130.

As shown in FIG. 6, the meta-lens 100A causes the rays of incident light from the physical object to be condensed on the image surface 132 of the image sensor 130. The image sensor 130 detects the rays of incident light thus condensed. A configuration including the meta-lens 100A and the image sensor 130 is equivalent to an imaging device that takes an image of the physical object.

### Method for Fabricating Meta-Lens

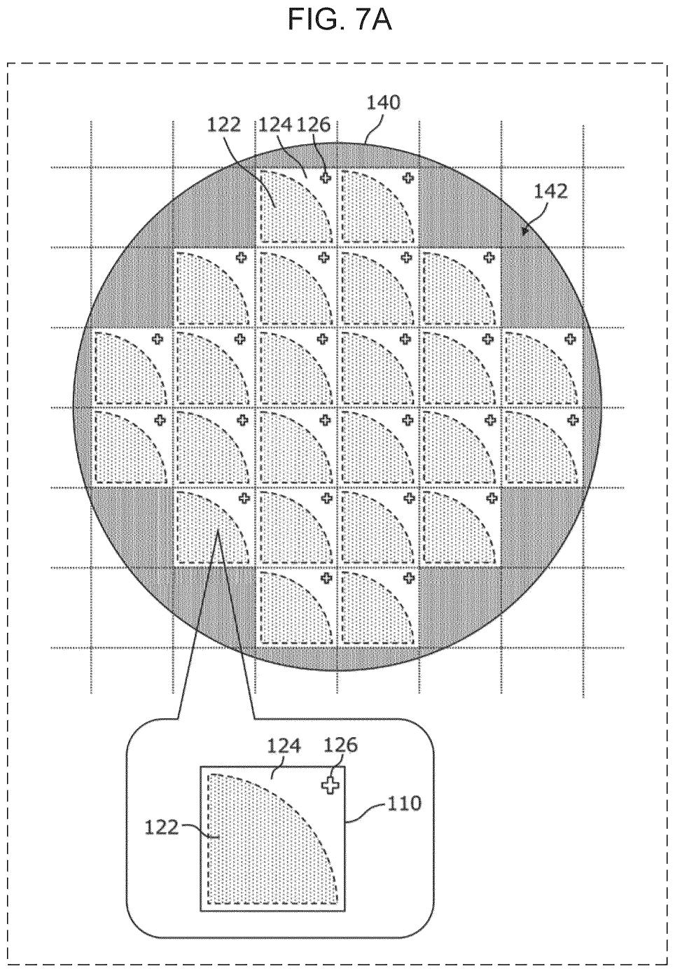

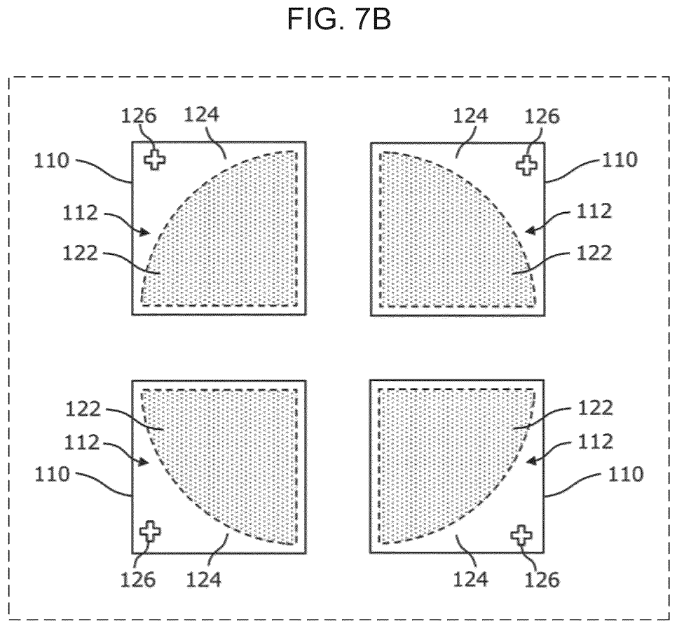

Next, a method for fabricating a meta-lens 100A according to Embodiment 1 is described with reference to FIGS. 7A and 7B. FIGS. 7A and 7B are diagrams for explaining the method for fabricating a meta-lens 100A according to Embodiment 1.

In the initial step, as shown in FIG. 7A, a circular semiconductor wafer 140 is prepared. The semiconductor wafer 140 includes a plurality of lens areas 122 arrayed two-dimensionally and a plurality of non-lens areas 124 arrayed two-dimensionally. Each of the non-lens areas 124 is located around a corresponding one of the lens areas 122 and surrounds the corresponding lens area 122. Of a surface 142 of the semiconductor wafer 140, each lens area 122 is provided with a plurality of microstructural bodies 120, and each non-lens area 124 is not provided with a plurality of microstructural bodies 120. However, as shown in FIG. 7A, each non-lens area 124 may be provided with an alignment mark 126. Although, in the example shown in FIG. 7A, the number of lens areas 122 is 24, the actual number of lens areas 122 can be, for example, larger than or equal to 10² and smaller than or equal to 10⁴. The same applies to the number of non-lens areas 124.

The semiconductor wafer 140 is obtained by providing a patterned resist on an unprocessed semiconductor wafer, removing unnecessary portions from the unprocessed semiconductor wafer by etching, and then removing the patterned resist. The dark hatched area shown in FIG. 7A represents an area on the semiconductor wafer 140 that is located around the plurality of lens areas 122 and the plurality of non-lens areas 124. The area is an area that was covered with the resist and that therefore remains unchanged from the unprocessed semiconductor wafer without being etched.

The patterned resist is obtained by processing, by photolithography, a resist applied onto the unprocessed semiconductor wafer. In the photolithography, an operation of exposing the resist via a photomask and a projector lens in this order is repeatedly executed with varying points of exposure. The photomask has a pattern of a lens area 122 and an alignment mark 126 in one substrate 110. The projector lens causes the pattern of the photomask to be transferred onto the resist in reduced size. Developing the resist thus exposed gives the patterned resist.

In the next step, a plurality of substrates 110 are obtained by dicing the semiconductor wafer 140 into individual pieces. Each substrate 110 is as shown in an enlarged view. A blade passes through the space between the plurality of lens areas 122. The reticular pattern of vertical and horizontal dotted lines shown in FIG. 7A represents lines of passage of the blade. The smallest gap between two adjacent ones of the plurality of lens areas 122 is wider than the width of the blade. This makes it possible to, even with passage of the blade, reduce the possibility that a microstructural body 120 located near an end of each lens area 122 may become damaged due to contact with the blade. The non-lens areas 124 are margin areas that remain around the substrates 110 obtained by dividing the semiconductor wafer 140 into pieces.

Each of the non-lens areas 124 has two long and thin portions that are adjacent to two linear portions of the corresponding lens area 122, which has the shape of a quarter circle, and a wide portion that is adjacent to an arc portion of the corresponding lens area 122. In a case where the width of each of the long and thin portions of the non-lens area 124 is, for example, less than or equal to 10 μm, the lens area 122 can be widened. The width of each of the long and thin portions may be constant or may not be constant.

On the other hand, if the long and thin portions of the non-lens area 124 are too narrow, there is a possibility that a microstructural body 120 located near the linear portion of the lens area 122 may become damaged in a case where an object comes into contact with an end of the substrate 110. Such a possibility can be reduced in a case where the width of the non-lens area 124 is wider than the maximum value of the spacing between two adjacent microstructural bodies 120 in the lens area 122.

In the next step, as shown in FIG. 7B, four substrates 110 are prepared from the plurality of substrates 110 obtained by dicing. These four substrates 110 constitute the meta-lens 100A. As shown in FIG. 4, a surface 112 of each substrate 110 is provided with a plurality of microstructural bodies 120.

In the next step, as shown in FIG. 4, the four substrates 110 are arrayed in two rows and two columns in an appropriate orientation. Side surfaces of two adjacent ones of the four substrate 110 are bonded to each other.

In a case where the arc portion of each lens area 122 faces outward in a regular square shape formed by the four substrates 110, the four lens areas 122 function as a single lens. In a case where the four alignment marks 126 are located in the four corners of the regular square shape, the arc portion of each lens areas 122 faces outward.

In the example shown in FIG. 7B, the upper left substrate 110 is equivalent to the upper right substrate 110 turned counterclockwise 90 degrees. The lower left substrate 110 is equivalent to the upper right substrate 110 turned counterclockwise 180 degrees. The lower right substrate 110 is equivalent to the upper right substrate 110 turned counterclockwise 270 degrees.

Through all these steps, the meta-lens 100A according to Embodiment 1 can be fabricated. In the photolithography, the range of one exposure via a photomask and a projector lens measures approximately several centimeters per side. In a case where the photomask has a pattern of a single lens in the photolithography, each of a plurality lens areas on a semiconductor wafer functions as a single lens. Although a meta-lens that functions as a single lens is obtained by dividing the semiconductor wafer into pieces, the meta-lens is limited in size.

On the other hand, in a case where the photomask has a pattern of part of a single lens, each of the lens areas 122 on the semiconductor wafer 140 functions as part of a single lens. Of the plurality of substrates 110 obtained by dividing the semiconductor wafer 140 into pieces, four substrates 110 are arrayed in two rows and two columns in an appropriate orientation, whereby a large-size meta-lens 100A that functions as a single lens can be fabricated. The meta-lens 100A makes it possible to increase the amount of light that is received.

### Modification of Embodiment 1

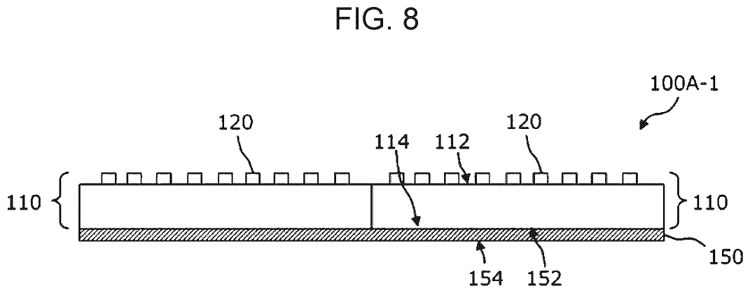

Next, a modification of the meta-lens 100A according to Embodiment 1 is described with reference to FIG. 8. FIG. 8 is a side view schematically showing a modification of the meta-lens 100A according to Embodiment 1. The meta-lens 100A-1 shown in FIG. 8 includes a different substrate 150 in addition to the four substrates 110. The four substrates 110 are placed at a surface 152 of the difference substrate 150. A back surface 114 of each substrate 110 is bonded to the surface 152 of the different substrate 150 so as to face part of the surface 152. This bonding, for example, may be adhesive bonding or may be non-adhesive direct bonding.

In a case where the different substrate 150 has a certain or higher level of rigidity, the different substrate 150 can function as a support substrate that supports the four substrates 110. Such a different substrate 150 can bring about improvement in mechanical strength of the meta-lens 100A-1. In a case where the four substrates 110 are supported by the different substrate 150, side surfaces of two adjacent ones of the four substrates 110 may be bonded to each other or may not be bonded to each other. In a case where the side surfaces of the two adjacent substrates 110 are not bonded to each other, the two adjacent substrates 110 may be placed at such a spacing from each other as not to affect the function of the single lens. A different substrate 150 having a certain or higher level of rigidity can be composed, for example, of a material whose Young's modulus is higher than or equal to 1 GPa, higher than or equal to 10 GPa, higher than or equal to 50 GPa, or higher than or equal to 100 GPa.

The different substrate 150 may have an anti-reflection function against light falling on the back surface 154. Even in a case where the different substrate 150 does not have such an anti-reflection function as to reduce the reflection of the incident light to several percent or less, the reflection of the light falling on the back surface 154 of the different substrate 150 can be reduced, as long as the refractive index of the different substrate 150 is lower than the refractive index of each substrate 110.

The different substrate 150 may have a function other than an anti-reflection function. For example, the different substrate 150 may have the function of any of a high-pass filter, a low-pass filter, or a band-pass filter that transmits only light in the target wavelength range. Alternatively, the different substrate 150 may be a polarization filter having a function of transmitting only particular polarized light of the incident light. Further, the different substrate 150 may be a filter having a function of attenuating or amplifying the transmission intensity of incident light in a particular wavelength range. The different substrate 150 may be an ND (neutral density) filter. The different substrate 150 may have a function of refracting incident light at a particular angle. The different substrate 150 can be constituted by a single layer or multiple layers according to a desired light modulation function. Further, the different substrate 150 can be made using a film-forming method such as a vacuum evaporation method or a sputtering method.

As noted above, in the modification of the meta-lens 100A according to Embodiment 1, in a case where the different substrate 150 functions as a support substrate, the mechanical strength of the meta-lens 100A-1 can be improved. The different substrate 150 may have, for example, an anti-reflection function, a transmitting function, a polarizing function, or a refracting function against incident light in addition to functioning as a support substrate. Alternatively, the different substrate 150 may have, for example, an anti-reflection function, a transmitting function, a polarizing function, or a refracting function against incident light while not functioning as a support substrate.

### Embodiment 2

### Configuration of Meta-Lens

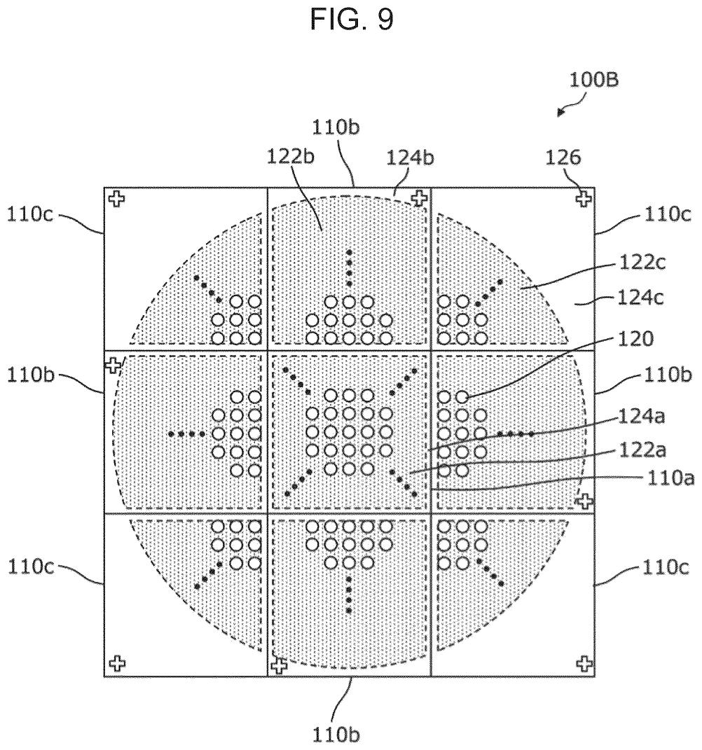

A configuration of a meta-lens according to Embodiment 2 of the present disclosure is described with reference to FIG. 9. FIG. 9 is a diagram schematically showing a configuration of a meta-lens according to an exemplary Embodiment 2 of the present disclosure. The meta-lens 100B shown in FIG. 9 includes nine substrates 110a to 110c arrayed two-dimensionally or, more specifically, in three rows and three columns. The nine substrates 110a to 110c include a centrally located substrate 110a, four substrates 110b located on the left, right, top, and bottom of the substrate 110a, and four substrates 110c located at the upper left, the upper right, the lower left, and the lower right. Side surfaces of two adjacent substrates 110a and 110b face each other. The same applies to side surfaces of two adjacent substrates 110b and 110c. As is the case with the meta-lens 100A-1 shown in FIG. 8, the meta-lens 100B may further include a different substrate 150.

Each of the substrates 110a to 110c has the shape of a regular square. The nine substrates 110a to 110c form the shape of a regular square. Of the nine substrates 110a to 110c, two adjacent substrates 110a and 110b have their side surfaces bonded to each other. The same applies to side surfaces of two adjacent substrates 110b and 110c. This bonding, for example, may be adhesive bonding or may be non-adhesive direct bonding.

The substrate 110a has a lens area 122a and a non-lens area 124a located outside the lens area 122a. Similarly, each of the substrates 110b has a lens area 122b and a non-lens area 124b located outside the lens area 122b. Each of the substrates 110c has a lens area 122c and a non-lens area 124c located outside the lens area 122c. More specifically, the non-lens area 124a is located around the lens area 122a and surrounds the lens area 122a. Similarly, the non-lens area 124b is located around the lens area 122b and surrounds the lens area 122b. The non-lens area 124c is located around the lens area 122c and surrounds the lens area 122c. Each of the lens areas 122a to 122c includes a plurality of microstructural bodies 120, and none of the non-lens areas 124a to 124c includes a plurality of microstructural bodies 120. However, as shown in FIG. 9, each of the non-lens areas 124a to 124c may include an alignment mark 126.

The nine lens areas 122a to 122c are not identical in shape to one another. The lens area 122a is equivalent to a central portion of nine portions into which a single circular lens has been divided in a reticular pattern. The four lens areas 122b have identical shapes and are equivalent to the left, right, upper, and lower portions of the nine portions in which the single lens has been divided in a reticular pattern. The four lens areas 122c have identical shapes and are equivalent to the upper left, upper right, lower left, and lower right portions of the nine portions in which the single lens has been divided in a reticular pattern. Since the nine lens areas 122a to 122c are not identical in shape to one another, the nine non-lens areas 124a to 124c are not identical in shape to one another, either.

All microstructural bodies in the nine substrates 110a to 110c include a plurality of microstructural bodies 120 within each of the substrates 110a to 110c. Of the nine substrates 110a to 110c, two adjacent substrates 110a and 110b are separated from each other by a boundary, and two adjacent substrates 110b and 110c are separated from each other by a boundary. As in the case of the meta-lens 100A according to Embodiment 1, the spacing d1 between two of all microstructural bodies that are adjacent to each other via the boundary is different from the spacing d2 between two of all microstructural bodies that are adjacent to each other within each of the substrates 110a to 110c. More specifically, the minimum value of the spacing d1 is greater than the maximum value of the spacing d2. The maximum value of the spacing d1 is five times or less as great as the maximum value of the spacing d2.

According to Embodiment 2, a larger-size meta-lens 100B that functions as a single lens can be achieved by arraying the nine substrates 110a to 110c, whose lens areas 122a to 122c are not identical in shape to one another, in three rows and three columns in an appropriate orientation. Since the meta-lens 100B according to Embodiment 2 is larger in size than the meta-lens 100A according to Embodiment 1, the meta-lens 100B makes it possible to further increase the amount of light that is received.

### Method for Fabricating Meta-Lens

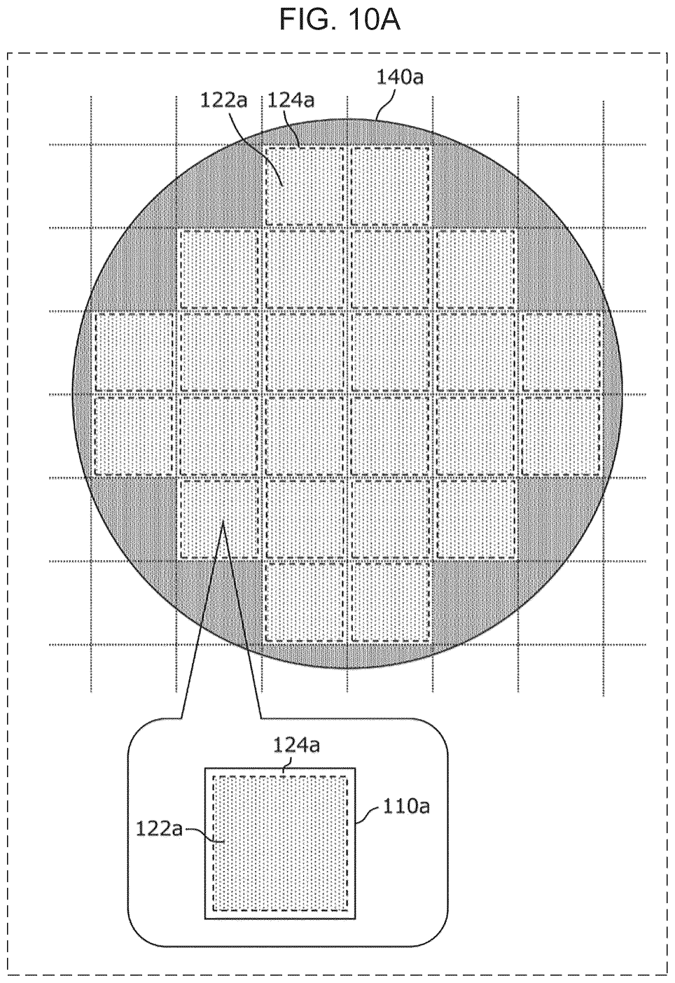

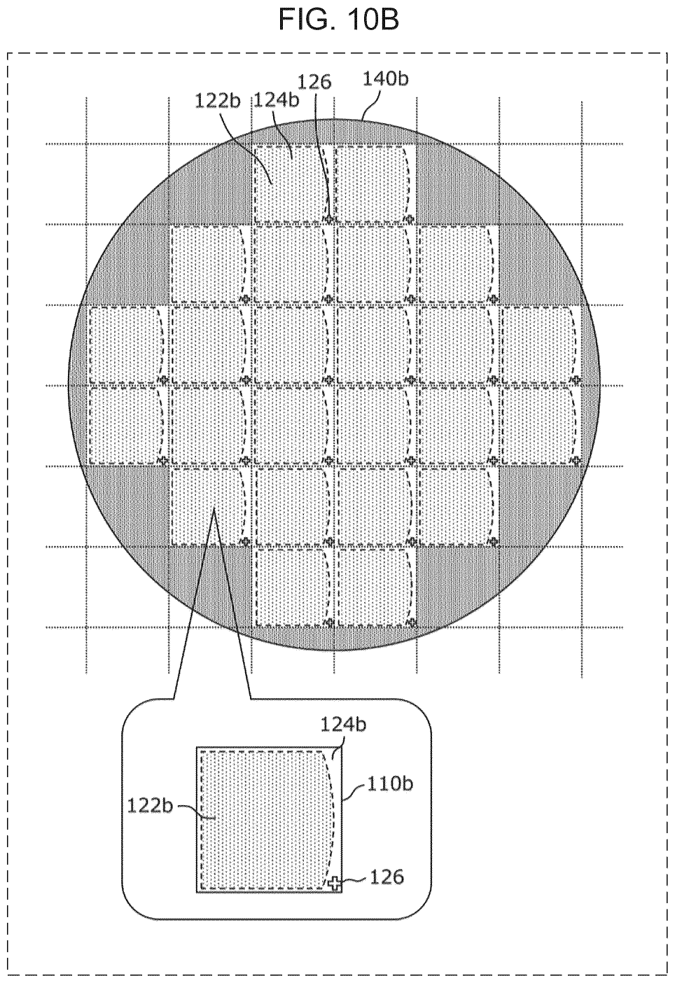

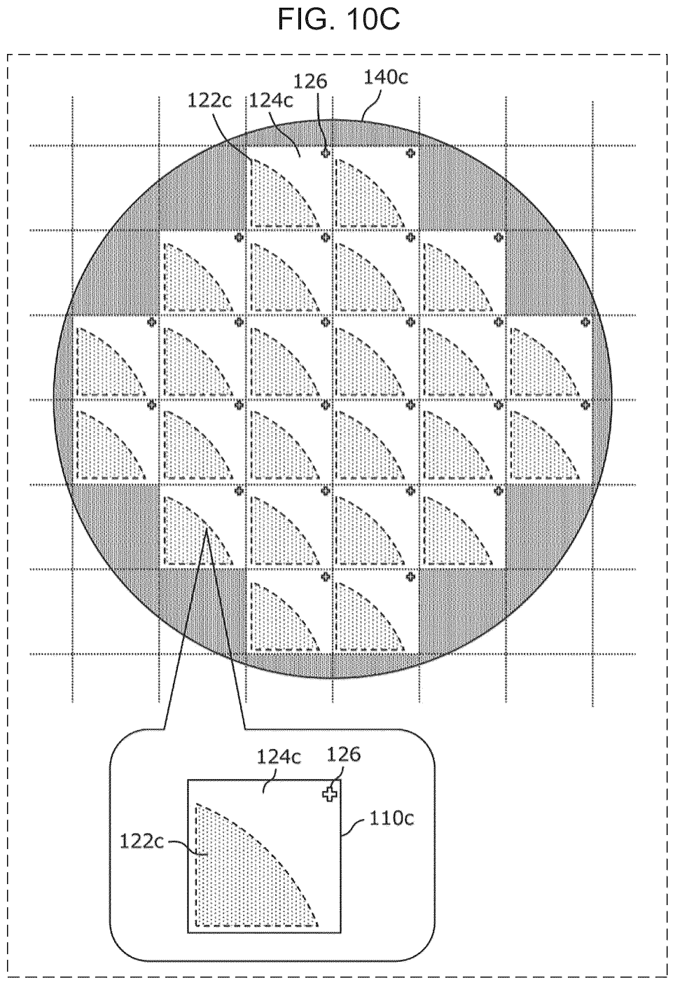

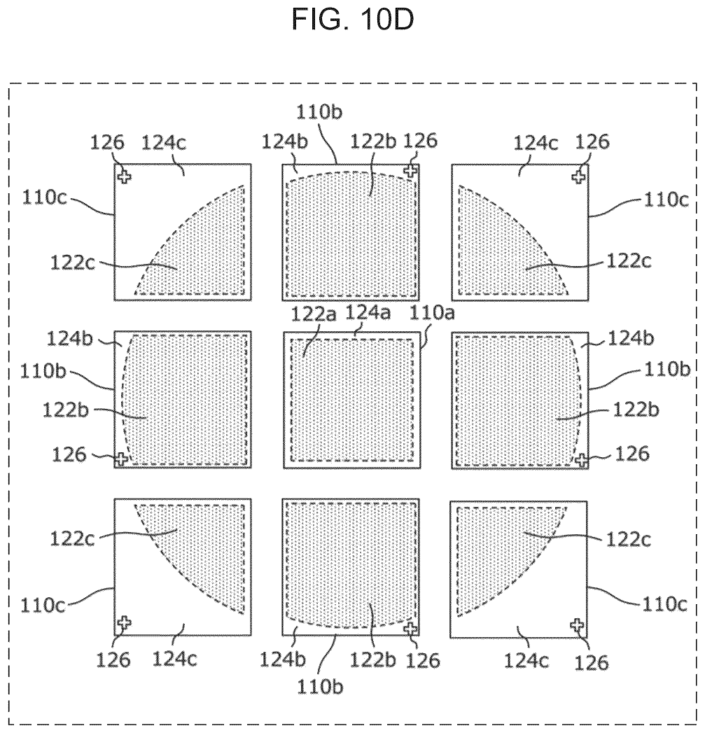

Next, a method for fabricating a meta-lens 100B according to Embodiment 2 is described with reference to FIGS. 10A to 10D. FIGS. 10A to 10D are diagrams for explaining the method for fabricating a meta-lens 100B according to Embodiment 2.

In the initial step, as shown in FIG. 10A, a circular semiconductor wafer 140a is prepared. The semiconductor wafer 140a includes a plurality of lens areas 122a arrayed two-dimensionally and a plurality of non-lens areas 124a arrayed two-dimensionally. Each of the non-lens areas 124a is located around a corresponding one of the lens areas 122a and surrounds the corresponding lens area 122a. In the next step, a plurality of substrates 110a are obtained by dicing the semiconductor wafer 140a into individual pieces so that a blade passes through the space between the plurality of lens areas 122a. Each substrate 110a is as shown in an enlarged view.

The foregoing two steps are also executed on circular semiconductor wafers 140b and 140c shown in FIGS. 10B and 10C. The semiconductor wafer 140b includes a plurality of lens areas 122b arrayed two-dimensionally and a plurality of non-lens areas 124b arrayed two-dimensionally. Each of the non-lens areas 124b is located around a corresponding one of the lens areas 122b and surrounds the corresponding lens area 122b. The semiconductor wafer 140c includes a plurality of lens areas 122c arrayed two-dimensionally and a plurality of non-lens areas 124c arrayed two-dimensionally. Each of the non-lens areas 124c is located around a corresponding one of the lens areas 122c and surrounds the corresponding lens area 122c.

The lens areas 122a to 122c are formed by the same method as are the lens areas 122 shown in FIG. 7A. Long and thin portions of the non-lens areas 124a to 124c are equal in width to long and thin portions of the non-lens areas 124 shown in FIG. 7A. That is, the width of each of the long and thin portions of each of the non-lens areas 124a to 124c can be, for example, less than or equal to 10 μm. The width of each of the long and thin portions of each of the non-lens areas 124a to 124c is, for example, wider than the maximum value of the spacing between two adjacent microstructural bodies 120 in a corresponding one of the lens areas 122a to 122c.

Alternatively, nine substrates 110a to 110c that are included in the meta-lens 100B can also be obtained by dividing, into pieces, a single semiconductor wafer having one or more lens areas 122a, four or more lens areas 122b, and four or more lens areas 122c. However, in forming the semiconductor wafer, a resist is exposed with varying photomasks according to the lens areas 122a to 122c.

On the other hand, the semiconductor wafer 140a shown in FIG. 10A allows a resist to be exposed without varying photomasks in photolithography. This makes it easy to fabricate the semiconductor wafer 140a. The same applies to the semiconductor wafers 140b and 140c shown in FIGS. 10B and 10C.

In the next step, as shown in FIG. 10D, nine substrates 110a to 110c that constitute the meta-lens 100B are prepared from the plurality of substrates 110a to 110c obtained by dividing the semiconductor wafers 140a to 140c into pieces. In the next step, as shown in FIG. 9, the nine substrates 110a to 110c are arrayed in three rows and three columns in an appropriate orientation. Of the nine substrates 110a to 110c, two adjacent substrates 110a and 110b have their side surfaces bonded to each other, and two adjacent substrates 110b and 110c have their side surfaces bonded to each other.

In a regular square shape formed by the nine substrates 110a to 110c, the arc portion of each of the four left, right, upper, and lower lens areas 122b faces outward, and the arc portion of each of the four upper left, upper right, lower left, and lower right lens areas 122c faces outward. Since the central lens area 122a has 4-fold rotational symmetry in the regular square shape, the lens area 122a may be turned 90 degrees, 180 degrees, or 270 degrees. Such nine lens areas 122a to 122c function as a single lens.

In a case where the alignment marks 126 of the four substrates 110b are located near the ends of the regular square shape, the arc portion of each lens area 122b faces outward. In a case where the alignment marks 126 of the four substrates 110c are located in the four corners of the regular square shape, the arc portion of each lens area 122c faces outward.

In the example shown in FIG. 10D, the left substrate 110b is equivalent to the upper substrate 110b turned counterclockwise 90 degrees. The lower substrate 110b is equivalent to the upper substrate 110b turned counterclockwise 180 degrees. The right substrate 110b is equivalent to the upper substrate 110b turned counterclockwise 270 degrees. Similarly, the upper left substrate 110c is equivalent to the upper right substrate 110c turned counterclockwise 90 degrees. The lower left substrate 110c is equivalent to the upper right substrate 110c turned counterclockwise 180 degrees. The lower right substrate 110c is equivalent to the upper right substrate 110c turned counterclockwise 270 degrees.

Through all these steps, the meta-lens 100B according to Embodiment 2 can be fabricated.

Although each of the meta-lenses 100A and 100B according to Embodiments 1 and 2 described above has the shape of a regular square, it is not limited to the shape of a regular square. Each of the meta-lenses may have any shape such as a rectangular shape, a circular shape, an elliptical shape, or a polygonal shape.

Furthermore, although, in each of the meta-lenses 100A and 100B according to Embodiments 1 and 2, the single lens has the shape of a circle, it is not limited to the shape of a circle. The single lens may have any shape such as a rectangular shape, a circular shape, an elliptical shape, or a polygonal shape.

Furthermore, although, in each of the meta-lenses 100A and 100B according to Embodiments 1 and 2, the single lens is divided into four parts or nine parts, it is not limited to such division. The single lens may be divided into two parts, three parts, or five to eight parts or may be divided into ten or more parts.

Furthermore, although, in each of the meta-lenses 100A and 100B according to Embodiments 1 and 2, the plurality of substrates 110 or 110a to 110c are arrayed two-dimensionally, they are not limited to such an array. The plurality of substrates 110 or 110a to 110c may be arrayed one-dimensionally.

### Shapes and Materials of Constituent Elements

Each microstructural body 120 can be, for example, a convex body having a circular cylindrical shape. Alternatively, each microstructural body 120 may have a shape other than a circular cylinder. For example, each microstructural body 120 may be a columnar body having the shape of an elliptic cylinder or a polygonal column other than a circular cylinder. Alternatively, each microstructural body 120 may be a conical body having the shape of an elliptic cone (including a circular cone) or a polygonal cone. Furthermore, each microstructural body 120 is not limited to a convex body but may be a concave body. A concave body or a convex body constituting a microstructural body 120 can have any structure such as a columnar body having the shape of an elliptic cylinder or a polygonal column or a conical body having the shape of an elliptic cone or a polygonal cone.

Each of the substrates 110 can be divided into a flat plate portion having the surface 112 and the plurality of microstructural bodies 120 provided at the surface 112. The flat plate portion and each microstructural body 120 may be made of an identical material or may be made of different materials. For reduction of unwanted reflection or refraction between the flat plate portion and an array of the plurality of microstructural bodies 120, the difference between the refractive index of the flat plate portion and the refractive index of each microstructural body 120 may be, for example, lower than or equal to 10%, lower than or equal to 5%, or lower than or equal to 3% of the minimum refractive index of the refractive index of the flat plate portion and the refractive index of each microstructural body 120.

The materials of the flat plate portion, each microstructural body 120, the different substrate 150, and the adhesive are as follows.

In a case where the predetermined target wavelength range is ultraviolet radiation, visible light, or near-infrared radiation (from approximately 700 nm to approximately 2.5 μm), the flat plate portion may be made, for example, from a material whose main component is at least one selected from the group consisting of glass, a cycloolefin copolymer, a cycloolefin polymer, polycarbonate, and fluorene-based polyester. The term “main component” here refers to a component contained in the material in the highest proportion when expressed in mol percentage. Each microstructural body 120 may be made from a material main component is at least one selected from the group consisting of TiO₂, Si₃N₄, GaN, GaP, diamond, HfO₂, AlN, and Si. In a case where the flat plate portion and each microstructural body 120 are made from the aforementioned materials, the refractive index of each microstructural body 120 is higher than the refractive index of the flat plate portion. The material of the difference substrate 150 can be, for example, the same as the material of the flat plate portion.

In a case where the predetermined target wavelength range is mid-infrared radiation (from approximately 2.5 μm to approximately 4 μm) or far-infrared radiation (from approximately 4 μm to approximately 1 mm), the flat plate portion, each microstructural body 120, and the different substrate 150 may be made, for example, from a material whose main component is at least one selected from the group consisting of silicon, germanium, chalcogenide, chalcohalide, zinc sulfide, zinc selenide, fluoride compounds, thallium halide, sodium chloride, potassium chloride, potassium bromide, cesium iodide, and plastic (such as polyethylene).

In a case where the predetermined target wavelength range is ultraviolet radiation, visible light, near-infrared radiation, mid-infrared radiation, or far-infrared radiation, the adhesive may be made, for example, from a material whose main component is polyimide resin.

The refractive indices and materials of the substrates 110a to 110c are the same as the refractive indices and materials of the substrates 110.

### CONCLUSION

The foregoing description of embodiments discloses the following technologies.

### Technology 1

An optical lens including a plurality of substrates arrayed two-dimensionally or one-dimensionally, wherein a surface of each of the plurality of substrates is provided with a plurality of microstructural bodies corresponding to part of a single lens.

This optical lens makes it possible to increase the size of the optical lens by arraying the plurality of substrates.

### Technology 2

The optical lens according to technology 1, wherein sides surfaces of two adjacent ones of the plurality of substrates face each other.

This optical lens makes it possible to increase the size of the optical lens by arraying the plurality of substrates so that the side surfaces of the two adjacent substrates face each other.

### Technology 3

The optical lens according to technology 1 or 2, wherein sides surfaces of two adjacent ones of the plurality of substrates are bonded to each other.

This optical lens makes it possible to increase the size of the optical lens by arraying the plurality of substrates so that the side surfaces of the two adjacent substrates are bonded to each other.

### Technology 4

The optical lens according to any of technologies 1 to 3, wherein the surface of each of the plurality of substrates is provided with an alignment mark.

This optical lens makes it possible to place the plurality of substrates in an appropriate orientation.

### Technology 5

The optical lens according to any of technologies 1 to 4, further including a different substrate, wherein the plurality of substrates are placed at a surface of the different substrate.

This optical lens makes it possible to achieve a new function with the different substrate.

### Technology 6

The optical lens according to technology 5, wherein a refractive index of the different substrate is lower than a refractive index of each of the plurality of substrates.

This optical lens makes it possible to reduce the reflection of incident light with the different substrate.

### Technology 7

The optical lens according to technology 5 or 6, wherein the different substrate functions as a support substrate that supports the plurality of substrates.

This optical lens can bring about improvement in mechanical strength of the optical lens with the different substrate.

### Technology 8

The optical lens according to any of technologies 5 to 7, wherein the different substrate has an anti-reflection function, a transmitting function, a polarizing function, or a refracting function against incident light.

This optical lens makes it possible to prevent the reflection of the incident light or transmit, polarize, or refract the incident light with the different substrate.

### Technology 9

The optical lens according to any of technologies 1 to 8, wherein
all microstructural bodies in the plurality of substrates include the plurality of microstructural bodies within each substrate,
two adjacent ones of the plurality of substrates are separated from each other by a boundary, and
a spacing between two of all microstructural bodies that are adjacent to each other via the boundary is different from a spacing between two of all microstructural bodies that are adjacent to each other within each substrate.

This optical lens can function as a single lens even in the aforementioned case.

### Technology 10

A method for fabricating an optical lens, the method including:
preparing a plurality of substrates that constitute the optical lens; and
arraying the plurality of substrates two-dimensionally or one-dimensionally,
wherein a surface of each of the plurality of substrates is provided with a plurality of microstructural bodies corresponding to part of a single lens.

This method for fabricating an optical lens makes it possible to fabricate a large-size optical lens.

### Technology 11

The method according to technology 10, further including dicing, into individual pieces, a semiconductor wafer having a plurality of lens areas arrayed two-dimensionally,
wherein the dicing precedes the preparing, and
each of the plurality of lens areas includes the plurality of microstructural bodies.

This method for fabricating an optical lens makes it possible to form a plurality of substrates by dicing the semiconductor wafer into individual pieces.

An optical lens of the present disclosure is widely applicable to lens-equipped devices such as cameras, LiDAR sensors, projectors, AR displays, telescopes, microscopes, and optical scanners.

What is claimed is:

1. An optical lens functioning as a single lens against incident light, the optical lens comprising a plurality of substrates,
wherein
each of the plurality of substrates has, on a surface on which the incident light is incident, a principal area that serves as a portion of the single lens and in which a plurality of microstructural bodies is provided at predetermined spacings that are smaller than a wavelength of the incident light,
the plurality of substrates include a plurality of first substrates each having, on the surface, a peripheral area in which the plurality of microstructural bodies are not provided and that serves as an outer side of the single lens, and
the plurality of substrates are arranged two-dimensionally or one-dimensionally in a direction parallel to the surface so that the principal areas of the plurality of substrates are joined to each other to form the single lens and the peripheral areas of the plurality of first substrates form an outer shape of the single lens.

2. The optical lens according to claim 1, wherein each of the plurality of substrates has the plurality of microstructural bodies placed at the predetermined spacings in an area measuring several centimeters per side.

3. The optical lens according to claim 1, wherein the outer shape is a circular shape, an elliptical shape, a rectangular shape, or a polygonal shape.

4. The optical lens according to claim 1, wherein
the peripheral areas of the plurality of first substrates have arc portions at boundaries with the principal areas, and
the arc portions of the plurality of first substrates are joined to each other to form the outer shape of the single lens into a circular shape.

5. The optical lens according to claim 1, wherein
each of the plurality of first substrates has, at an end thereof, an end area in which the plurality of microstructural bodies are not provided, and
the end area is smaller in amount of space than the peripheral area.

6. The optical lens according to claim 5, further comprising two microstructural bodies that are adjacent to each other via the end area,
wherein
each of the two microstructural bodies is one of the plurality of microstructural bodies provided in a different one of the plurality of first substrates, and
a spacing between the two microstructural bodies is greater than the predetermined spacings and five times or less as great as the predetermined spacings.

7. The optical lens according to claim 1, wherein
the peripheral area of each of the plurality of first substrates is provided with an alignment mark, and
four of these alignment marks are located in four corners, respectively, of the optical lens.

8. The optical lens according to claim 1, further comprising, at sides of the plurality of substrates opposite to the surface, a different substrate having such a size that the plurality of substrates are placed.

9. The optical lens according to claim 8, wherein a refractive index of the different substrate is lower than a refractive index of each of the plurality of substrates.

10. The optical lens according to claim 8, wherein the different substrate functions as a support substrate that supports the plurality of substrates.

11. The optical lens according to claim 8, wherein the different substrate has an anti-reflection function, a transmitting function, a polarizing function, or a refracting function against the incident light.

12. The optical lens according to claim 1, wherein side surfaces of two adjacent ones of the plurality of substrates are bonded to each other.

13. The optical lens according to claim 1, wherein the plurality of substrates include a second substrate, placed in a central part of the single lens, that has the principal area on the surface and does not have the peripheral area.

14. A method for fabricating an optical lens including a plurality of substrates and functioning as a single lens against incident light,
each of the plurality of substrates having, on a surface on which the incident light is incident, a principal area that serves as a portion of the single lens and in which a plurality of microstructural bodies is provided at predetermined spacings that are smaller than a wavelength of the incident light,
the plurality of substrates including a plurality of first substrates each having, on the surface, a peripheral area in which the plurality of microstructural bodies are not provided and that serves as an outer side of the single lens,
the method comprising:
preparing the plurality of substrates; and
arraying the plurality of substrates two-dimensionally or one-dimensionally in a direction parallel to the surface,
wherein the arraying causes the principal areas of the plurality of substrates to be joined to each other to form the single lens and causes the peripheral areas of the plurality of first substrates to form an outer shape of the single lens.

15. The method according to claim 14, further comprising, prior to the preparing:
creating, on a semiconductor wafer, a plurality of surfaces corresponding to the plurality of substrates at which the plurality of microstructural bodies are formed, an exposure that is performed on the plurality of microstructural bodies at the predetermined spacings in an exposure range measuring several centimeters per side being repeated more than once with varying positions; and
fabricating the plurality of substrates by dicing the semiconductor wafer for each of the plurality of surfaces.
